(19) United States
(12) Patent Application Publication
(10) Pub. No.: US 2004/0010111 A1
(43) Pub. Date: Jan. 15, 2004

(54) Adhesives for dvd bonding

(76) Inventors: David P. Birkett, Naas (IE); Alan E Litke, Waterbury, CT (US); Steven T Nakos, Andover, CT (US)

Correspondence Address: Henkel Loctite Corporaton, Legal Department, 1001 Trout Brook Crossing, Rocky Hill, CT, 06067, US

(21) Appl. No.: 10/416,740

(22) PCT Filed: Dec. 15, 2000
(86) PCT No.: PCT/US00/34164

(51) Int. Cl. C08G 18/00

(52) U.S. Cl. 528/44; 525/242; 525/293

(57) ABSTRACT

Curable (meth)acrylate adhesives are formulated with aliphatic urethane (meth)acrylate resins. The resins are urethane (meth)acrylate capped polyols wherein the urethane acrylate capping is derived from isophorone diisocyanate and a hydroxyalkyl (meth)acrylate and the polyol is an oligomeric aliphatic diol or triol having a number average molecular weight of from about 1500 to about 3500. The hydroxyalkyl (meth)acrylate may be hydroxy ethyl acrylate. The polyol may be a member selected from the group consisting of polyoxypropylene triols, polyTHF diols, polycaprolactone/polyTHF block copolymers, and polycaprolactone diols. The adhesives give good adhesion to common DVD substrate materials, and display excellent corrosion resistance in dissimilar metal bonding applications.

### FIELD OF THE INVENTION

The present invention pertains to digital video disk (DVD) and other assemblies prepared using certain adhesives, to bonding methods employing such adhesives and to novel curable (meth)acrylate-based adhesives and novel urethane/(meth)acrylate resins.

### BACKGROUND OF THE INVENTION

In the preparation of digital video disks (DVDs), a laminate is prepared by adhesive bonding of at least two polycarbonate substrates at interface layers which often comprise dissimilar materials. Typically, at least one interface layer is sputter coated aluminum, while the other may be polycarbonate, sputter coated aluminum, or more recently a dissimilar metal or semiconductor such as silver, gold or silicon.

Adhesives used in DVD bonding have included radiation curable (meth)acrylate adhesives based on oligomeric urethane methacrylate resins and liquid (meth)acrylate monomers.

Suitable radiation curable (meth)acrylate adhesives for DVD bonding applications should be able to effectively bond all such combinations with good bond durability. In particular, corroding of the sputtered aluminum can occur due to electrochemical reactions between the dissimilar metals if the adhesive is ionically conductive or becomes so under certain environmental conditions. With the recent introduction of dissimilar metal bonding requirements in DVD adhesion, corrosion has become a problem for some adhesives previously formulated for DVD applications. The problem is especially severe with bonding of substrates having interface layers of aluminum and silver. Consequently there is a need for improved DVD adhesive formulations which display good or better adhesion to the various types of substrates and which also provide improved durability characteristics.

Radiation curable (meth)acrylic adhesives employing many other components, urethane acrylate resins and certain adhesion promoter compounds are described in WO 00/40663, application PCT/IE00/00001, the entire disclosure of which is incorporated herein by reference.

EP 889465 describes a photocurable protection coating and adhesion composition which includes which includes a bi-functional urethane acrylate oligomer, an epoxy acrylate containing a bisphenol A skeleton, a N-vinyl lactam compound, a phosphine oxide photoinitiator and a phenolic antioxidant.

WO 98/45344 describes a radiation curable binder composition made by mixing a polymer, oligomer or monomer having at least on (meth)acrylate group, an oligomer or monomer, other than a (meth)acrylate, which has ethylenic unsaturation, and an elongation promoter.

U.S. Pat. No. 5,320,933 describes a photoimageable composition which contains a carboxyl-containing polymer, a photopolymerizable monomer, a photoinitiator and an acrylamido-acid compound adhesion promoter.

U.S. Pat. No. 4,348,427 describes a coating composition employing an epoxy acrylate resin, an α,Ω-acrylic polyester resin, an unsaturated polyester or urethane acrylate resin, and an unsaturated amide, lactam, piperidone or urea compound.

U.S. Pat. No. 5,698,285 describes an optical disk adhesive comprising a radical-polymerizable vinyl compound and a photoinitiator comprising a mixture of an acylphosphine oxide and an α-aminoacetophenone compound.

U.S. Pat. No. 5,663,211 describes an ultraviolet curing resin cor an optical disk which includes a multi(meth)acrylate functional monomer, a di(meth)acrylate functional monomer, a diluent, an adhesion promoter, and a photopolymerization initiator.

### SUMMARY OF THE INVENTION

The invention is based on the discovery that curable adhesives formulated with certain aliphatic urethane (meth)acrylate resins also give remarkably improved durability in dissimilar metal bonding applications. Such adhesives also give comparable or improved adhesion to common DVD substrates compared to comparable adhesives formulated with nominally similar resins. More particularly, the invention pertains to curable (meth)acrylate ester adhesive formulations, particularly for those destined for application in bonding polar plastics, such as polycarbonate or acrylic, and metals such as aluminum and silver, gold or silicon, notably as occurs in the manufacture of optical or video disk assemblies. The adhesive formulations of the invention include:

An aliphatic urethane (meth)acrylate resin which is a urethane (meth)acrylate capped polyol wherein the urethane (meth)acrylate capping is derived from isophorone diisocyanate and a hydroxyalkyl (meth)acrylate;

the polyol is an oligomeric diol or triol having a number average molecular weight of from about 1500 to about 3500.

The inventive adhesive formulations may also be advantageously employed in the manufacture of medical devices, such as needles, and electronic devices.

Desirably, these formulations are curable through exposure to radiation in the electromagnetic spectrum.

Further aspects of the invention include a bonding method employing an adhesive formulation of the invention and bonded assemblies produced with such adhesive, especially DVD assemblies.

### BRIEF DESCRIPTION OF THE FIGURES

FIGS. 1A-C show schematic cross-section depictions of optical disks, depicting respectively a single sided; double sided, single layer; and a single sided, dual layer, each assembled with an adhesive formulation in accordance with the present invention.

FIG. 2 shows a schematic cross-section of an optical disk assembled with an adhesive formulation in accordance with the present invention.

### DETAILED DESCRIPTION OF THE INVENTION

All published documents and/or pending applications mentioned anywhere in this application are hereby expressly incorporated herein by reference in their entirety.

The inventive formulations employ an oligomer or “prepolymer” resin which is a urethane (meth)acrylate capped oligomeric diol or triol having a number average molecular weight of about 1500 to about 3500, wherein the urethane (meth)acrylate capping is derived from isophorone diisocyanate (IPDI) and a hydroxyalkyl (meth)acrylate. These urethane acrylate resins may be prepared by reacting a suitable polyol, with isophorone diisocyanate and a hydroxyalkyl (meth)acrylate. This resin component is suitably employed in the inventive adhesive formulations in amounts of from about 2 to about 98% by weight, preferably about 10 to about 65, more preferably about 15 to about 50% by weight.

For DVD bonding applications, the adhesive formulations preferably are substantially free (less than 0.1% by weight) of hydroxyalkyl acrylate monomers and consequently the resin is desirably prepared in a manner which does not require removal of unreacted hydroxyalkyl (meth)acrylate starting material. This can be accomplished by first reacting the hydroxyalkyl (meth)acrylate with a large excess of IPDI, preferably using a ratio of substantially 0.9-1.1:2.0 hydroxy equivalents from the hydroxyalkyl (meth)acrylate: NCO equivalents from IPDI to produce an isocyanato functional urethane acrylate capping agent. Due to the large excess NCO at this time the hydroxyalkyl (meth)acrylate is completely consumed. Depending on the exact ratios employed and the reaction conditions, the capping agent product may also include a small amount of unreacted IPDI and/or a small amount of a bis-(meth)acrylate product resulting from the reaction of 2 molecules of hydroxyalkyl (meth)acrylate with 1 molecule of IPDI. This capping agent product may then reacted be reacted without isolation or purification with the specified polyol on the basis of about one equivalent of hydroxy groups to each remaining equivalent of NCO in the capping agent product. This process can provide a resin which has less than 0.1% by weight hydroxyalkyl (meth)acrylate, typically less than 0.05%, thereby allowing preparation of the desired substantially free adhesive formulation.

In an alternative method, the IPDI may be first reacted to cap the polyol and then the isocyanato terminated product reacted with the hydroxyalkyl (meth)acrylate.

Polyols which may be employed in the manufacture of the urethane (meth)acrylate resins utilized in the inventive compositions are oligomeric aliphatic diols or triols having a number average molecular weight of from about 1500 to about 3500, preferably from about 1800 to about 2800. Preferred oligomeric aliphatic diols and triols are polyoxypropylene triols, polyTHF diols, polycaprolactone/polyTHF block copolymers, and polycaprolactone diols.

The polyoxypropylene triols which may be employed in the manufacture of the urethane (meth)acrylate resins utilized in the inventive compositions may be derived from glycerol, trimethylolpropane or another triol which has been alkoxylated with propylene glycol to give a product having a number average molecular weight as specified above. Suitable such polyoxypropylene triols are PLURACOL® TP-2540, and PLURACOL® EP 1437, from BASF, which are respectively, a trimethylol started polyoxypropylene triol having a number average molecular weight of about 2450 and a glycerol started polyoxypropylene triol having a number average molecular weight of approximately 2500.

The polyTHF diols which may be employed in the manufacture of the urethane (meth)acrylate resins utilized in the inventive compositions are also known as a polytetramethylene oxide, or polybutylene glycol. The diol is typically produced by a ring opening polymerization of tetrahydrofuran (THF). A suitable such polyTHF diol is POLYMEG 2000, sold by Penn Specialties and having a number average molecular weight of approximately 2000.

The polycaprolactone/polyTHF block copolymers which may be employed in the manufacture of the urethane (meth)acrylate resins utilized in the inventive compositions may be polycaprolactone-co-polyTHF-polycaprolactone diols of the specified molecular weights. A suitable example is CAPA-720, sold by Solvay-Interox.

Polycaprolactone diols within the specified molecular weight range also may be employed in the manufacture of the urethane (meth)acrylate resins utilized in the inventive compositions.

The hydroxyalkyl (meth)acrylate used to produce the urethane acrylate resins employed in the inventive adhesives may be, e.g., hydroxyethyl methacrylate, hydroxypropyl methacrylate, hydroxybutyl methacrylate, hydroxyethyl acrylate, hydroxypropyl acrylate or hydroxybutyl acrylate. Acrylates are preferred, especially hydroxyethyl acrylate.

The inventive adhesives will typically include at least one other (meth)acrylate ester compound. Such compounds include a wide variety of materials represented by H₂C═CR¹CO₂R², where R¹ may be hydrogen, halogen or alkyl of 1 to about 4 carbon atoms, and R² may be selected from alkyl, cycloalkyl, alkenyl, cycloalkenyl, alkaryl, aralkyl or aryl groups of 1 to about 16 carbon atoms, any of which may be optionally substituted or interrupted as the case may be with silane, silicon, oxygen, halogen, carbonyl, hydroxyl, ester, carboxylic acid, urea, urethane, carbamate, amine, amide, sulfur, sulfonate, sulfone and the like.

More specific (meth)acrylate compounds which may be additionally included in the inventive adhesives include polyethylene glycol di(meth)acrylates, bisphenol-A di(meth)acrylates, such as ethoxylated bisphenol-A methacrylate (“EBIPMA”) and tetrahydrofuran (meth)acrylates and di(meth)acrylates, hydroxypropyl (meth)acrylate, hexanediol di(meth)acrylate, trimethylol propane tri(meth)acrylate, ethoxylated trimethylol propane tri(meth)acrylates, (meth)acrylated polyesters and an acrylate ester corresponding to the structure shown below:

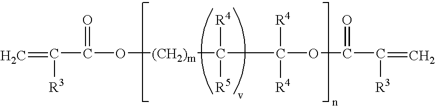

where R³ may be selected from hydrogen, alkyl of 1 to about 4 carbon atoms, hydroxyalkyl of 1 to about 4 carbon atoms or

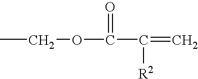

R⁴ may be selected from hydrogen, halogen, and alkyl of 1 to about 4 carbon atoms;

R⁵ may be selected from hydrogen, hydroxy and

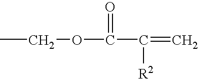

m is an integer equal to at least 1, e.g., from 1 to about 8 or higher, for instance, from 1 to about 4;

n is an integer equal to at least 1, e.g., 1 to about 20 or more; and

v is 0 or 1.

Of course, combinations of these (meth)acrylate ester monomers may also be used. As already noted, preferred adhesives for DVD bonding do not include hydroxyalkyl (meth)acrylates.

Such additional (meth)acrylate compounds are suitably utilized as diluents and as cured property modifiers. In preferred embodiments they are employed in an amount adjusted to provide a formulation viscosity of from 80 to 800 mPa.s, more preferably 120 to 650 mPa.s. In general acrylate compounds are preferred as diluent compounds. Preferred diluents include isobornyl acrylate, isodecyl acrylate, tetrahydrofuryl acrylate and ethoxyethoxyethyl acrylate, and mixtures thereof.

Various adhesion promoters may be used including

N,N′-dimethylacrylamide, acryloyl morpholine and the adhesion promoters described in WO 00/40663, for instance N-methyl-N-vinyl acetamide, N-vinyl caprolactam, N-vinylphthalimide, Uracil, and N-vinylpyrrolidone, alone or in combination. The adhesion promoter or promoters may suitably be employed in the adhesive formulations of the invention in an amount from about 2% to about 30% by weight of the composition, more typically 5% to about 20% by weight, and particularly about 15% by weight. While any such adhesion promoter may be useful herein, to the extent N N′-dimethylacryamide and/or acryloyl morpholine is chosen, it is desirable to include these adhesion promoters in an amount less than about 3% by weight. Of course, either or both may be used in combination with each other, or the other adhesion promoters cited. Alternatively such adhesion promoters may be employed in primer compositions applied to one or both of the substrate layers before the inventive adhesives are applied and cured.

In the aspect of the invention where the adhesive formulations are curable through exposure to radiation in the electromagnetic spectrum, a photoinitiator component should also be included. The photoinitiators that may be used in the adhesive compositions of the present invention include, but are not limited to, photoinitiators available commercially from Ciba-Geigy Corp., Tarrytown, N.Y. under the “IRGACURE” and “DAROCUR” tradenames, specifically “IRGACURE” 184 (1-hydroxycyclohexyl phenyl ketone), 907 (2-methyl-1-[4-(methylthio)phenyl]-2-morpholino propan-1-one), 369 (2-benzyl-2-N,N-dimethylamino-1-(4-morpholinophenyl)-1-butanone), 500 (the combination of 1-hydroxy cyclohexyl phenyl ketone and benzophenone), 651 (2,2-dimethoxy-2-phenyl acetophenone), 1700 (the combination of bis(2,6-dimethoxybenzoyl-2,4-,4-trimethyl pentyl phosphine oxide and 2-hydroxy-2-methyl-1-phenyl-propan-1-one) and “DAROCUR” 1173 (2-hydroxy-2-methyl-1-phenyl-1-propane) and 4265 (the combination of 2,4,6-trimethylbenzoyldiphenyl-phosphine oxide and 2-hydroxy-2-methyl-1-phenyl-propan-1-one); photoinitiators available commercially from Union Carbide Chemicals and Plastics Co. Inc., Danbury, Conn. under the “CYRACURE” tradename, such as “CYRACURE” UVI-6974 (mixed triaryl sulfonium hexafluoroantimonate salts) and UVI-6990 (mixed triaryl sulfonium hexafluorophosphate salts); and the visible light [blue] photoinitiators, dl-camphorquinone and “IRGACURE” 784DC. Of course, combinations of these materials may also be employed herein.

Photoinitiators particularly suitable for use herein include ultraviolet photoinitiators, such as 2,2-dimethoxy-2-phenyl acetophenone (e.g., “IRGACURE” 651), and 2-hydroxy-2-methyl-1-phenyl-1-propane (e.g., “DAROCUR” 1173) and the ultraviolet/visible photoinitiator combination of bis(2,6-dimethoxybenzoyl-2,4,4-trimethylpentyl) phosphine oxide and 2-hydroxy-2-methyl-1-phenyl-propan-1-one (e.g., “IRGACURE” 1700), as well as the visible photoinitiator bis(η⁵-2,4-cyclopentadien-1-yl)-bis[2,6-difluoro-3-(1H-pyrrol-1-yl)phenyl]titanium (e.g., “IRGACURE” 784DC). LUCIRIN TPO, from BASF is another preferred photoinitiator.

When used, the photoinitiator may be used in an amount of from about 0.5 to about 10% by weight of the adhesive formulation, such as about 2 to about 7% by weight.

Alternatively, the adhesive formulations of the present invention may be rendered curable anaerobically, when an anaerobic cure-inducing composition is included in the formulation, and the formulation is applied to a substrate that is then placed in an environment in which air is excluded.

Such an anaerobic cure-inducing composition useful in the present invention includes a variety of components, such as amines (including amine oxides, sulfonamides and triazines). A desirable composition to induce cure in accordance with the present invention includes saccharin, toluidines, such as N,N-diethyl-p-toluidine and N,N-dimethyl-o-toluidine, acetyl phenylhydrazine, and maleic acid. Of course, other materials known to induce anaerobic cure may also be included or substituted therefor. See e.g., Loctite U.S. Pat. No. 3,218,305 (Krieble), U.S. Pat. No. 4,180,640 (Melody), U.S. Pat. No. 4,287,330 (Rich) and U.S. Pat. No. 4,321,349 (Rich). Quinones, such as naphthoquinone and anthraquinone, may also be included to scavenge free radicals which may form.

The adhesive formulations of the present invention may be used on a variety of different surfaces, including metallic surfaces, such as steel, aluminum, copper, gold, silver, and zinc bichromate. In addition, the present invention may be used on ordinarily difficult to bond to substrates, such as non-ferrous materials, plastics, silicon, ceramics and wood.

The present invention also provides methods of using the adhesives of the invention to bond substrates by applying the adhesive formulation to a substrate, optionally coated with a cure promoting or adhesion promoting primer, joining the substrates and then curing the adhesive. In addition, the present invention further provides articles manufactured with the inventive adhesive formulations.

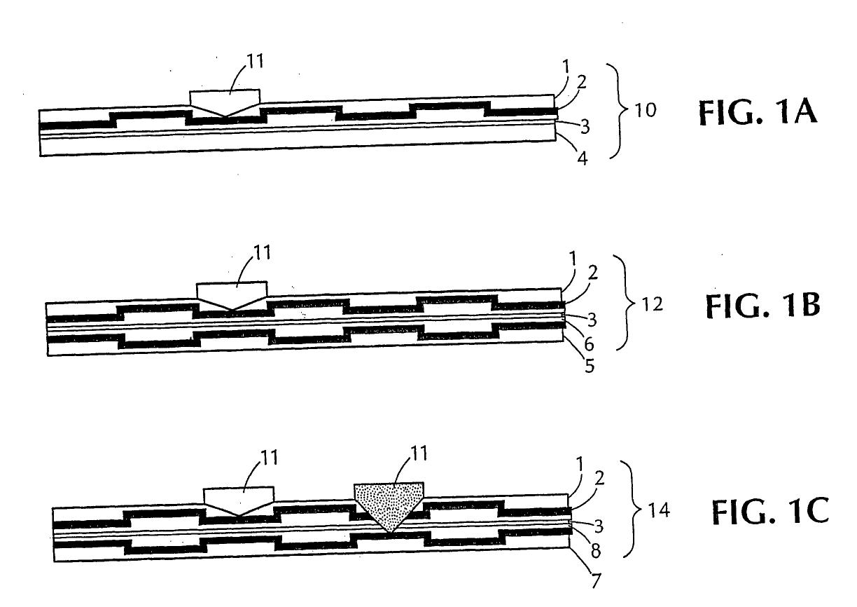

Now, with reference to FIGS. 1A-1C, the present invention will be described in the context of manufacturing an DVD optical disk assembly.

FIGS. 1A-C show schematic cross-sections of optical disk assemblies, designated respectively as 10, 12 and 14. With the assemblies is also shown the focal point of a lens 11 for reading information prerecorded on the disks.

These assemblies of various configurations of pre-recorded high density optical disks. Referring first to FIG. 1A, typically, data is stamped into a circular transparent substrate 1, such as one constructed from polycarbonate. A reflective layer 2, typically aluminum, is then deposited over the data-stamped substrate. This aluminum-deposited data-stamped substrate, constituting a half disk, may then be bonded with a bonding adhesive 3 to a second substrate half disk 4, which may also be constructed from polycarbonate, but having no data stamped therein. This assembly is representative of a single sided disk assembly 10. Reflective layer 2 may also be made of silver.

In an alternative embodiment shown in FIG. 1B, the aluminum-deposited or silver-deposited data-stamped substrate half disk 1 may be bonded with a bonding adhesive 3 to another data-stamped substrate half disk 5 on which is deposited a reflective layer 6 of aluminum or silver. This assembly is representative of a double sided, single layer disk assembly 12.

In another alternative embodiment shown in FIG. 1C, the aluminum-deposited or silver-deposited data-stamped substrate half disk 1 may be bonded with a bonding adhesive 3 to a data-stamped substrate half disk 7 coated with a layer 8 that is both semi-transparent and semi-reflective, such as gold, silver or silicon. This assembly is representative of a single sided, dual layer disk assembly 14.

Two methods are commonly used to form the adhesive layer. In the first method, adhesive may be dispensed close to the center of one of the substrates, then spread over the entire surface of the substrate using centripetal force, as the substrate spins about a central post. The second substrate is then mated with the adhesive-coated substrate, and held in place for the requisite period of time (and in the case of photocurable adhesives, exposed to radiation in the appropriate range of the electromagnetic spectrum) to cure the adhesive and form the assembly.

In the second method, the two substrates may be brought together, and the adhesive injected between them at a location close to the center. The adhesive can then be spread out over the entirety of the internal surfaces of the assembly using the weight of the upper substrate to force the adhesive outward, capillary action, centripetally as above, or a combination thereof. In the case of photocurable adhesives, the assembly is exposed to radiation in the appropriate range of the electromagnetic spectrum to cure the adhesive and form the assembly.

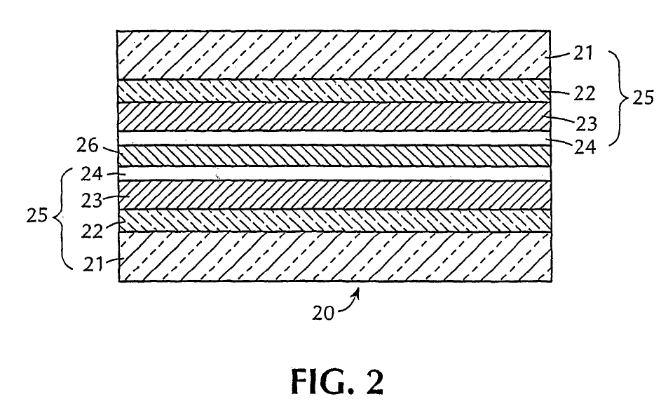

As regards recordable disks, reference to FIG. 2 is illustrative in which, a recording layer 22, typically a dye or phase change material, is formed on a transparent substrate 21 of resin, such as, for example, polycarbonate, and then coated with a reflective layer 23, typically gold or silver, followed by a protective film layer 24, suitably of UV cured acrylic laquer. The substrate 21 and the layers 22-24 form a disk unit 25. Two such disk units 25, are bonded to each other at the exposed surfaces of the respective protective film layers 24 with an adhesive layer 26 to form the optical disk 20. In bonding the disk units 24 together, an adhesion promoter composition may initially be coated on either or both of such exposed surfaces, and thereafter the inventive adhesive formulation may be applied over the adhesion promoter-coated surface. Alternatively, the inventive adhesive formulation may be coated directly on either or both of such exposed surfaces.

In another technique for bonding two disk units 25, a first disk unit 25 is positioned with the recording layer 22 facing upward. The inventive adhesive formulation is applied over the protective film 24 in generally concentric circles. A second disk unit 25 is aligned with the first disk unit 25 by a center shaft of the disk manufacturing apparatus, and the protective film 24 of the second disk unit 24 is brought into contact with the coating of adhesive formulation. The adhesive is allowed to spread over the entire surfaces of the protective films of the resultant assembly due to the weight of the disk unit and by virtue of capillary action, and the adhesive is caused to cure to bond the two disk units together.

A single-sided recordable disk may also be made by bonding a single disk unit 25 directly to a second substrate disc 21.

In the case of adhesive formulations curable by exposure to electromagnetic radiation, the adhesive layer is exposed to such light from the back side of the bonding surface(s).

If the film thickness of the protective film for the recording layer of the optical disk becomes undesirably thick, in certain instances, one or more of the substrates used to assemble the disk unit may tend to warp. A reproducing apparatus may misread or be prevented from reading the recorded information on a warped disk. Therefore, it is important to ensure that the disk thickness of the protective film does not exceed the thickness recited above. The adhesive formulations to be used in a spin coating method, as described above, should have a low viscosity, such as less than about 900 mPa.s, and desirably below about 400 mPa.s, such as below about 250 mPa.s for coating through capillary action.

The invention is illustrated by the following non-limiting examples where, unless otherwise noted, percentages are weight percentages and molecular weights are number average molecular weights.

### EXAMPLES

### Urethane Acrylate Resin Syntheses

### Example 1

### From Propoxylated TMP

2-Hydroxyethyl acrylate (50.00 g, 0.43 moles) was added dropwise to a stirred reaction vessel containing isophorone diisocyanate (95.65 g, 0.430 moles) and dibutyltin dilaurate catalyst (0.26 g, 0.05 wt %) at 65° C., keeping the reaction exotherm to 80° C. The reaction mixture was stirred at 65° C. for 1.5 hours under dry air, after which it was titrated with HCl for NCO (measured 2.894 meq/g).

A calculated amount (371.01 g, 0.506 moles) of the polyol PLURACOL TP 2540, corrected for measured hydroxyl number (62.8) and water content (150 ppm), and bismuth octoate (0.26 g, 0.05 wt %) was then added, with a slight exotherm seen. The temperature was raised to 90° C. and stirred for 2 hours. IR of the mixture showed a trace of NCO.

The product was transferred into a storage bottle (yield 508.3 g) and analyzed for trace NCO by titration with HCl (measured <0.001 meq/g).

### Examples 2-4

### From Other Polyols

Using essentially the same procedure as described above, adjusted for polyol equivalent weight, the following polyols were used to prepare urethane acrylate resins of the invention:

Example 2 PLURACOL EP 1437, propoxylated glycerol, 2500 mol. weight

Example 3 POLYMEG 2000, polyTHF diol, 2000 mol. weight

Example 4 CAPA-720 polycaprolactone-co-polyTHF-co-polycaprolactone diol, 2000 mol. wt.

### Adhesives

Adhesive formulations curable upon exposure to ultraviolet radiation were prepared by mixing together the individual constituents set forth in Table 1, where the resin was varied as indicated for the respective examples below;

TABLE 1
Formulation

| | |
|---|---|
| Resin | 40 |
| Isobornyl Acrylate | 27 |
| N,N-dimethylacrylamide | 21 |
| Ethoxylated trimethylolpropane triacrylate | 5 |
| IRGACURE 184 | 5 |
| LUCIRIN TPO | 2 |

### Examples A-D (Comparative) & Examples 4-5 (Invention)

For Comparative Example A, the resin was a 50/50 mixture of EBERCRYL 3500, from UCB Radcure Inc., Smyrna Ga., and a commercial urethane methacrylate resin prepared by capping PLURACOL TP 2540 (trimethylolpropane started polyoxypropylene triol) with toluene diisocyanate and then hydroxyethyl methacrylate. The mixture is currently used in commercial DVD adhesive formulations.

For Comparative Example B, the resin was a commercial glycerol propoxylate capped with IPDI and hydroxyethyl acrylate, but cut with some diacrylate so that the average number of acrylate groups per molecule is between 2 and 3.

For Comparative Example C, the resin was a commercial polypropylene oxide urethane diacrylate.

For Comparative Example D, the resin was a commercial glycerol propoxylate capped with IPDI and hydroxyethyl acrylate, but cut with some diacrylate so that the average number of acrylate groups per molecule is between 2 and 3.

For Invention Example 5, the resin was the product of Example 1.

For Invention Example 6, the resin was the product of Example 2.

The adhesive formulations were prepared by mixing the respective resin described above with the remaining ingredients shown in Table 1, without regard to order of mixing.

The adhesives were evaluated according to standard procedures for lap shear adhesion performance on the following substrates: PC to PC (polycarbonate to polycarbonate) and PC to Al (polycarbonate to aluminum). Results are given in Table 2

The adhesives also were used to bond two disk units of a Si-DVD-9 assembly. The circular disk unit substrates were of the same dimension and aligned concentrically. The adhesive formulation was introduced between the substrates at a point toward their centers. Upon spinning the substrates about a rotating centerpost, the adhesive formulation spun away from the center to coat substantially the entirety of the facing substrate surfaces. The optical disk assembly was then exposed to ultraviolet radiation, to cure the adhesive formulation. The bonded Si-DVD-9 assembly was evaluated for durability as evidenced by visible corrosion of the assembly after aging at 82° C., 95% RH for 96 hrs. Results of the durability testing are also reported in Table 2.

TABLE 2

Lap Shear Results

| | PC to PC | PC to Al | Durability |
|---|---|---|---|
| Example | N/mm² | N/mm² | (visible corrosion) |
| A | 3.5 | 4.4 | Bad |
| B | 3.5 | 1.9 | Some |
| C | 3.6 | 3.8 | Some |
| D | 5.0 | 1.7 | Some |
| 5 | 4.6 | 3.7 | No |
| 6 | 4.9 | 4.2 | No |

The results shown in Table 2 demonstrate that the triol resins of the invention give better durability than the control (A) and the propoxylated commercial resins (B, C, D), and also show good adhesion on both sets of substrates, while the commercial propoxylated resins are more variable in adhesion.

### Example E (Comparative) & Examples 7-8 (Invention)

For Comparative Example E, the resin was a commercial resin mixture of ethoxylated trimethylolpropane triacrylate and a diacrylate derived from polyTHF diol (number average molecular weight of about 1000) by capping with IPDI and hydroxyethyl acrylate.

For Invention Example 7, the resin was the product of Example 3.

For Invention Example 8, the resin was the product of Example 4.

These resins, formulated into adhesives according to the recipe of Table 1, were evaluated in the same manner as the previous adhesive examples, except that the durability test was performed on a Silver-DVD-9 assembly (Al and Ag sputter coatings on the respective surfaces of the two disk units). Test results are given in Table 3.

TABLE 3

Lap Shear Results

| | PC to PC | PC to Al | Durability |
|---|---|---|---|
| Example | N/mm² | N/mm² | (visible corrosion) |
| E | SF | 3.8 | Yes |
| 7 | SF | 6.6 | Slight |
| 8 | SF | 5.3 | No |

SF = substrate failure

Table 3 demonstrates that the inventive adhesives show an advantage over the adhesive based on the commercially available similar material used in Example E, in terms of polycarbonate to aluminum adhesion, and the durability of Al to Ag bonded DVD disk assemblies.

### Examples 9-10

### Invention

Adhesives suitable for DVD bonding are prepared in accordance with Table 4, where the resin is a product as described in Example 1, above.

TABLE 4

| Formulation | Ex 9 | Ex 10 |
|---|---|---|
| Resin | 24.5 | 22 |
| CRANOR 704 (acrylated polyester) | 24.5 | 22 |
| N-vinyl caprolactam | 24 | 24 |
| Tetrahydrofuryl acrylate | 15 | 15 |
| Ethoxyethoxyethyl acrylate | 5 | 10 |
| IRGACURE 184 | 5 | 5 |
| LUCIRIN TPO | 2 | 2 |

The formulations have a viscosity of about 100 mPa.s and 180 mPa.s, respectively. The adhesives were evaluated in the same manner as the previous adhesive examples, except that the durability test was performed on an Si-DVD-9 assembly. Results are reported in Table 5.

TABLE 5

Lap Shear Results

| | PC to PC | PC to Al | Durability |
|---|---|---|---|
| Example | N/mm² | N/mm² | (visible corrosion) |
| 9 | 5.3 | 2.5 | no |
| 10 | SF | 2.6 | no |

SF = substrate failure

While the invention has been described in connection with what is presently considered to be the most practical and preferred embodiments, it is to be understood that the invention is not to be limited to the disclosed embodiments but, on the contrary, is intended to cover various modifications and equivalent arrangements included within the spirit and scope of the claims.

The above examples and disclosure are intended to be illustrative and not exhaustive. These examples and description will suggest many variations and alternatives to one of ordinary skill in this art. All these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. Claim 3 may be taken as alternatively dependent from claim 2; claim 4 may be taken as alternatively dependent on claim 2, or on claim 3; claim 6 may be taken as alternatively dependent from claim 5; etc.).

1. A curable (meth)acrylate adhesive formulation comprising an aliphatic urethane (meth)acrylate resin which is a urethane (meth)acrylate capped polyol wherein the urethane acrylate capping is derived from isophorone diisocyanate and a hydroxyalkyl (meth)acrylate, and the polyol is an oligomeric aliphatic diol or triol having a number average molecular weight of from about 1500 to about 3500.

2. An adhesive formulation as in claim 1 wherein the polyol molecular weight is in the range of from about 1800 to about 2800.

3. An adhesive formulation as in claim 1 wherein the polyol is a member selected from the group consisting of polyoxypropylene triols, polyTHF diols, polycaprolactone/polyTHF block copolymers, and polycaprolactone diols.

4. An adhesive formulation as in claim 1 further comprising a (meth)acrylate ester diluent.

5. An adhesive formulation as in claim 4 wherein said diluent includes a member selected from the group consisting of isobornyl acrylate, isodecyl acrylate, tetrahydrofuryl acrylate and ethoxyethoxyethyl acrylate, and mixtures thereof

6. An adhesive formulation as in claim 4 having a viscosity of from about 80 mPa.s to about 800 mPa.s.

7. An adhesive formulation as in claim 1, the formulation having not more than 0.1 by weight of unreacted hydroxyalkyl (meth)acrylates.

8. An adhesive formulation as in claim 1 further comprising an adhesion promoter.

9. An adhesive formulation as in claim 8 wherein said adhesion promoter is selected from the group consisting of N,N′-dimethylacrylamide, acryloyl morpholine, N-methyl-N-vinyl acetamide, N-vinyl caprolactam, N-vinylphthalimide, Uracil, N-vinylpyrrolidone and mixtures thereof.

10. An adhesive formulation as in claim 1 further comprising a photoinitiator component.

11. An adhesive formulation as in claim 10 wherein the photoinitiator component is a member selected from the group consisting of 1-hydroxycyclohexyl phenyl ketone, 2-methyl-1-[4-(methylthio)phenyl]-2-morpholino propan-1-one, benzophenone, 2-benzyl-2-N,N-dimethylamino-1-(4-morpholinophenyl)-1-butanone, 2,2-dimethoxy-2-phenyl acetophenone, bis(2,6-dimethoxybenzoyl-2,4-,4-trimethylpentyl) phosphine oxide, 2-hydroxy-2-methyl-1-phenyl-propan-1-one, 2-hydroxy-2-methyl-1-phenyl-1-propane, 2,4,6-trimethylbenzoyldiphenyl-phosphine oxide, 2-hydroxy 2-methyl-1-phenyl-propan-1-one, mixed triaryl sulfonium hexafluoroantimonate salts, mixed triaryl sulfonium hexafluorophosphate salts, visible light [blue] photoinitiators, dl-camphorquinone, and combinations thereof.

12. An adhesive formulation as in claim 1 wherein said hydroxyalkyl (meth)acrylate is an acrylate; the polyol molecular weight is in the range of from about 1800 to about 2800; the polyol is a member selected from the group consisting of polyoxypropylene triols, polyTHF diols, polycaprolactone/polyTHF block copolymers, and polycaprolactone diols; the formulation further comprises a (meth)acrylate ester diluent; and the formulation has no more than 0.1% by weight of unreacted hydroxyalkyl (meth)acrylates.

13. An adhesive as in claim 1 further comprising an anaerobic cure-inducing component.

14. An adhesive as in claim 1 wherein said hydroxyalkyl (meth)acrylate is an acrylate.

15. An adhesive as in claim 1 wherein said hydroxyalkyl acrylate is hydroxyethyl acrylate.

16. An assembly comprising a pair of substrates having mating surfaces adhesively joined by a cured adhesive as in claim 1.

17. An assembly as in claim 16 wherein said substrate mating surfaces are formed of materials selected from the group consisting of polycarbonate, silver, gold, aluminum, silicon and mixtures thereof.

18. An assembly as in claim 16 wherein the substrates comprise parts of an optical disk unit.

19. An assembly as in claim 16 wherein the optical disk unit is a digital video disk.

20. A medical device comprising an assembly as in claim 16.

21. An electronic device comprising an assembly as in claim 16.

22. An aliphatic urethane (meth)acrylate resin which is a urethane (meth)acrylate capped polyol wherein the urethane (meth)acrylate capping is derived from isophorone diisocyanate and a hydroxyalkyl acrylate, and the polyol is an oligomeric aliphatic diol or triol having a number average molecular weight of from about 1500 to about 3500.

23. A resin as in claim 22 wherein the hydroxyalkyl (meth)acrylate is hydroxyethyl acrylate.

24. A resin as in claim 22 wherein the wherein the polyol is a member selected from the group consisting of polyoxypropylene triols, polyTHF diols, polycaprolactone/polyTHF block copolymers, and polycaprolactone diols.

25. A resin as in claim 24 wherein the polyol molecular weight is in the range of from about 1800 to about 2800.

26. A resin as in claim 25 wherein the hydroxyalkyl (meth)acrylate is hydroxyethyl acrylate.

27. A resin as in claim 22, the resin having not more than 0.01 by weight of unreacted hydroxyalkyl (meth)acrylate.

28. An adhesive formulation as in claim 12 wherein the formulation has a viscosity of from about 80 mPa.s to about 800 mPa.s.
